(19) United States
(12) Patent Application Publication
(10) Pub. No.: US 2007/0188028 A1
(43) Pub. Date: Aug. 16, 2007

(54) Cooling conduit for a rotary electric machine and a rotary electric machine comprising said conduit

(75) Inventors: Claudiu Vasilescu, Paris (FR); Bruno Dessirier, St. Germain en Laye (FR)

Correspondence Address: MATTHEW R. JENKINS, ESQ., 2310 FAR HILLS BUILDING, DAYTON, OH, 45419, US

(73) Assignee: TELMA, Saint-Ouen-L'Aumone (FR)

(21) Appl. No.: 10/598,938

(22) PCT Filed: Mar. 17, 2005
(86) PCT No.: PCT/FR05/00650

§ 371 Date: Sep. 18, 2006

(30) Foreign Application Priority Data
Mar. 18, 2004 (FR) FR 0402806

(51) Int. Cl. H02K 9/20; H02K 9/00

(52) U.S. Cl. 310/54; 310/52

(57) ABSTRACT

The section of a cooling channel or conduit for a rotary electric machine comprises at least one tube which is mounted along at least one coolable part thereof and is provided with input and output axes, at least one coolant input and output connections, wherein the tube extends between said connections, each input and output connection is oriented at least approximately along the corresponding input or output axis of the tube and has a constant cross-sectional area along the entire longitudinal extent thereof. A rotary electric machine provided with said channel or conduit is also disclosed.

### BACKGROUND OF THE INVENTION

1. Field of the Invention

The invention concerns a length of a cooling channel or conduit for a rotary electrical machine, in particular for a rotary electrical machine equipping a motor vehicle, and a rotary electrical machine comprising such a length of a cooling channel or conduit.

2. Description of the Related Art

In the technical field of motor vehicles, the requirement for particularly well functioning cooling is not limited to the thermal engine by means of which the motor vehicle is driven, but also concerns auxiliary equipment such as an alternator, or an electromagnetic retarder intended to retard a transmission shaft of the vehicle. Whereas equipment such as an alternator is cooled by a cooling water circuit only in the case where air cooling, less constraining to install, proves insufficient, larger machines intended to undergo greater forces are almost routinely cooled by a liquid circulating in a cooling circuit. Such a fluid is for example water, it being understood that this water comprises at least one additive such as an antifreeze, for example, glycol. It circulates in a channel or conduit constituting, together with a heat exchanger, a cooling circuit.

In addition, whereas machines such as thermal engines are provided with a cooling channel or conduit consisting of a set of highly branched channels or conduits to make the cooling fluid pass practically in all corners of the machine, rotary electrical machines, such as an electromagnetic retarder, must be cooled by means of a simple channel or conduit intended to surround the machine to be cooled, for example a channel or conduit having the general form of a helix.

Traditionally, the input and output couplings coupling the length of cooling channel or conduit to the cooling circuit are formed by connecting pieces disposed perpendicular or inclined to the machine to be cooled.

In order to obtain sufficient cooling of the rotary machine, the cooling fluid must circulate in the circuit at a fairly high speed. And, in order to increase the cooling capacity, the circulation speed of the cooling fluid is increased. In addition, a better convection of the heat is obtained by generating turbulence in the flow of fluid.

However, it has been perceived that the traditional arrangement of couplings generates detrimental turbulence that does not therefore contribute to an increase in the cooling capacity of the fluid but on the contrary reduces it by increasing the pressure drops in the cooling circuit and thus reducing the flow of fluid and therefore its speed.

This is because the pressure drops are due to the friction of the fluid on the surface, related to turbulence, to the separation of the fluid relating to the progressive broadening of the channel or conduit of the circuit, to the impacts on the walls of the channel or conduit if the flow takes place with incidence, and to the change in direction of the flow.

What is needed therefore, is a system for providing improved cooling to a rotary electrical machine

### SUMMARY OF THE INVENTION

The aim of the invention is to propose means for improving the cooling of the rotary machine by a reduction in the pressure drops in the fluid circuit.

The invention is not limited to a certain type of machine nor to a certain type of channel or conduit. However, in order to simplify the description, the invention will be presented and defined, as far as the machine to be cooled is concerned, by means of the example of an electromagnetic retarder intended to retard and therefore brake a transmission shaft of a motor vehicle and, as far as the type of channel or conduit is concerned, principally by means of the example of a helical circuit. The second embodiment of the length concerns a circuit comprising channels or conduits that are essentially straight and parallel to each other.

An electromagnetic retarder and electrical supply means for the retarder form an assembly comprising in general a stator through which the shaft passes and a rotor intended to be assembled with the shaft so as to have an external cylindrical face close to an internal cylindrical face of the stator with a thin air gap interposed between the rotor and the stator. For example, the rotor comprises a field winding with coils of electric wires, able to generate a magnetic field in an annular ferromagnetic part of the stator, which constitutes the armature and which is associated with a circuit for cooling by means of a fluid such as water containing an additive as indicated above. The electrical supply to the coils is provided by means of an alternator whose armature forms part of the rotor, as described for example in the document EP-A-0 331 559, to which reference should be made for more information.

A rotary electrical machine such as, for example, an electromagnetic retarder can therefore be considered highly schematically as an appliance in two parts: the first part consists of the rotor that is in the form of a solid core intended to be attached to a shaft transmitting a motive force that it is sought to brake, and a stator having the form of a cylindrical chamber surrounding the rotor.

On the electrical level, as described in the document EP-A-0 331 559, the coils of electric wires that conduct the electric current energizing the retarder form part of the rotor, and the annular part made from ferromagnetic material in the chamber for generating eddy currents, generating braking and heating, forms part of the stator. In its most simple embodiment, the annular part made from ferromagnetic material consists of a cylindrical drum surrounding the field winding with the interposing of a cylindrical air gap. As the annular part made from ferromagnetic material is a fixed part, it can easily be cooled by means of a fluid without needing to have recourse to constructions including special seals intended to provide a seal between two parts in relative movement. To this end, a cooling channel or conduit is formed that runs directly along the face of the annular part made from ferromagnetic material, which is opposite to the air gap. The length of this channel or conduit that is in direct contact with the machine to be cooled extends for example in a helix around the annular part made from ferromagnetic material. It terminates at each of its two ends in a coupling, respectively input and output. The length of channel or conduit surrounding the machine to be cooled forms, in a motor vehicle equipped with such a rotary machine, together with an external heat exchanger, the remainder of the cooling channel or conduit and a drive pump, a cooling circuit dissipating a fairly large quantity of heat towards the outside. Advantageously, this cooling circuit of the rotary machine is connected to the cooling circuit of the thermal engine of the vehicle.

The aim of the invention is achieved with a length of cooling channel or conduit for a rotary electrical machine, the length of channel or conduit comprising at least one channel or conduit placed along at least part of the machine to be cooled, and at least one input coupling and at least one output coupling for a cooling fluid between which the channel(s) or conduit(s) extend. The circuit has an input axis and an output axis.

In accordance with the invention, the input coupling or couplings and the output coupling or couplings are each oriented at least approximately along the orientation of the corresponding input axis or output axis of the circuit. The input and output couplings have, like the circuits, an input axis and an output axis. In accordance with the invention, for the purpose of ensuring a speed of the cooling fluid that is as even as possible, the input coupling or couplings and the output coupling or couplings have, whatever their shape, all along their longitudinal extents, a constant area of their cross sections of flow.

By virtue of this provision of the invention, the cooling fluid immediately enters the length of cooling channel or conduit properly oriented, that is to say essentially without any change in direction, and therefore does not cause any turbulence by diversion of flow.

This improvement that the invention affords to the cooling system for rotary machines is particularly advantageous for cooling highly stressed rotary machines such as electromagnetic retarders used for industrial vehicles. However, it is also advantageous for cooling less stressed rotary machines such as water-cooled alternators.

This is because the better orientation of the flow of the cooling fluid arriving through the input coupling of the channel or conduit length is that which corresponds to the orientation of the axis or of the mid-plane of the start of the channel or conduit. Likewise, the better orientation of the cooling fluid flow starting from the output coupling of the channel or conduit length is that which corresponds to the orientation of the axis or mid-plane of the end of the channel or conduit.

The orientation described above of the input and output couplings of the length according to the invention moreover applies equally well to a length comprising several essentially straight channels or conduits disposed at least approximately parallel to the longitudinal axis of the machine to be cooled and to a length comprising at least one helical channel or conduit having at least one turn intended to surround at least part of this machine. In the first case, the input and output couplings are oriented at least approximately parallel to the longitudinal axis of the machine to be cooled and at the same time coaxially with respect to the channel or conduit to which they are allocated. In the second case, the input and output couplings are oriented respectively along a tangential input plane and a tangential output plane, each of them passing through a corresponding circumferential input or output zone of the helical channel or conduit of the length.

Moreover, in order to facilitate the connection of the cooling channel or conduit of the invention in the engine space of an industrial vehicle, the input coupling and the output coupling are disposed, according to an axial view of the rotary machine to be cooled, on the same side of the rotary machine and with a small angular offset between the two couplings.

In practice, this arrangement makes it possible to orient the rotary machine equipped with the channel or conduit length of the invention so that the input and output couplings are for example situated in the top part of the cooling channel or conduit.

The advantage of the orientation of the input and output couplings of a channel or conduit according to the invention is particularly remarkable when the channel or conduit length has an essentially helical shape and is formed by one or more successive chambers, each of which has only a single turn between its respective input and output. It is then a case rather of adjacent chambers.

This is because, when the helical channel or conduit has no wall intended to divide the channel or conduit into a plurality of turns, that is to say when the channel or conduit constitutes a single volume, it is particularly important to obtain a flow of cooling fluid free from turbulence originating in interference between the incoming flow and the outgoing flow and creating dead zones for the cooling with the fluid swirling on the spot.

The orientation of the input and output, according to the invention, of the flow of cooling fluid in a helical channel or conduit with a single turn is advantageously obtained by forming it by means of two complementary walls, an external wall and an internal wall, the internal wall being formed by the external surface of the stator of the machine to be cooled, and the external wall being formed by a single piece combining in itself the channel or conduit length with input coupling and output coupling. These two couplings are advantageously separated from each other by a changing low wall formed inside the single piece and conformed so as to on the one hand to give a favored direction of flow to the cooling fluid and on the other hand to ensure a constant area of the cross section of flow of the two couplings, mentioned above.

In a similar manner, it is possible to form a helical channel or conduit with two adjacent single turns by means of a single piece forming an external wall having a common input coupling and two separate output couplings or two separate input couplings and one common output coupling. This single piece then comprises two changing low walls, one for each turn.

In general terms, the number of input and output couplings and/or the number of low walls and turns can be greater than two.

All the aforementioned characteristics are to be considered separately or in combination.

The aim of the invention is also achieved with a rotary machine comprising a cooling channel or conduit length as described above.

The electrical machine is advantageously an electromagnetic retarder.

These and other objects and advantages of the invention will be apparent from the following description, the accompanying drawings and the appended claims.

### BRIEF DESCRIPTION OF THE ACCOMPANYING DRAWINGS

Other characteristics and advantages of the invention will emerge from the following description of an example embodiment of the invention, the description being given with reference to the drawings. In these drawings:

FIG. 1 depicts schematically a rotary machine comprising a circuit for cooling by liquid in which the input and output channels or conduits for the cooling liquid are connected radially to the outside of a cooling liquid jacket;

FIG. 2 depicts as a first embodiment of the length according to the invention, a transverse section of a length of a cooling channel or conduit in the form of a cooling fluid envelope with helical circuit;

FIG. 3 shows the cooling fluid envelope of FIG. 2 in a perspective view:

FIG. 4 and FIG. 5 show the form and the transverse section of a coupling of the length in FIG. 2;

FIGS. 6 and 7 show the input and output couplings of variant embodiments of the length in FIG. 2;

FIG. 8 shows a variant of the cooling fluid envelope in FIG. 3;

FIG. 9 shows the volume of fluid in the cooling fluid envelope in FIG. 8; and

FIGS. 10 and 11 show a second embodiment of the length according to the invention.

### DETAILED DESCRIPTION OF THE PREFERRED EMBODIMENTS

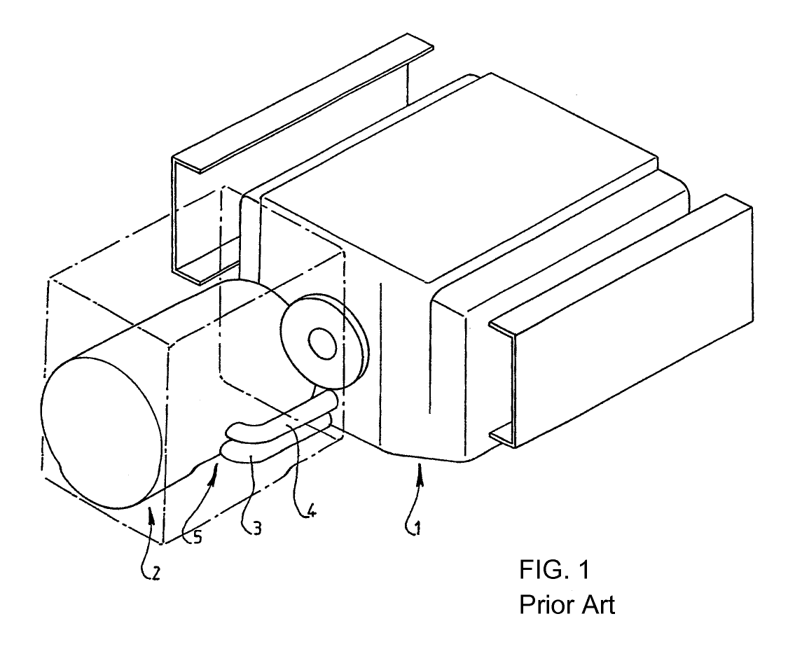

FIG. 1 repeats schematically the usual design, before the present invention, of rotary electrical machines cooled by a fluid, for example an electromagnetic retarder cooled by a water circuit. There can be seen therein more particularly a gearbox 1 with an output shaft that is rotationally integral by means of a speed multiplier, as described in the document WO2004/017502, with the shaft of a rotor of an electromagnetic retarder 2. This retarder 2 is cooled by a cooling circuit 5 comprising a water feed channel or conduit 3 and a water discharge channel or conduit 4. The channels or conduits 3 and 4 respectively arrive and depart on the water cooling circuit disposed inside the retarder 2 and consisting of a helical channel or conduit, at an essentially right angle with respect to the direction of flow of the water in the helical circuit.

Although this is not drawn in detail, it is easy to imagine the turbulence in the water flow and the losses in heat transfer capacity resulting therefrom, when the water arrives then radially on this water circuit or, in other words, at an approximate right angle with respect to the annular flow of the water and departs therefrom in a similar manner.

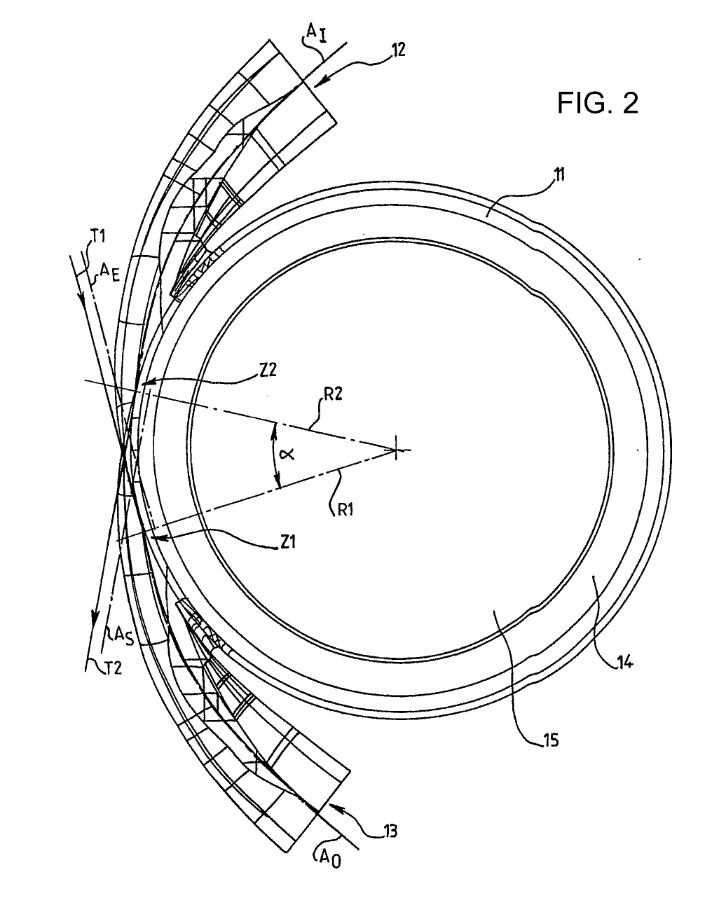

Contrary to this, a cooling circuit according to the invention, depicted in FIG. 2, for a rotary machine, comprises a length of cooling channel or conduit in the form of a helical channel or conduit 11 intended to surround a stator 14 and a rotor 15 of the rotary machine to be cooled. The channel or conduit 11 has one or more turns surrounding the machine to be cooled, with a tangential input coupling 12 and an output coupling 13. This channel or conduit 11 is integral with the stator 14. Here the channel or conduit is carried by the stator 14. The “tangential” characteristic indicates that the couplings 12 and 13 are each oriented, the input coupling 12 in a circumferential input zone Z1 and the output coupling 13 in a circumferential output zone Z2 of the channel or conduit 11, at least approximately at a tangent T1 passing through the center of the zone Z1 and approximately at a tangent T2 passing through the centre of the zone Z2. The centers of the zones Z1 and Z2 are determined by radii R1 and R2 ending on the circumference on the channel or conduit 11. In the axial view shown in FIG. 2, the angular offset a between the inlet Z1 and outlet Z2 zones can be noted in particular, which is favorably around 20° to 30°, but which can take any other value between 0° and 360° without departing from the principle of the present invention.

It is necessary moreover to state that the arrangement of the output coupling 13 with respect to the input coupling 12 with a relatively small angular difference as indicated above corresponds to the configuration considered to be advantageous for embodiments where the helical channel or conduit 11 surrounding the rotary machine comprises only one turn or a series of adjacent single turns. This arrangement has proved particularly effective and in particular more efficient than helical channel or conduits having several turns. This is because, when a portion of the cooling liquid is observed, which extends over the entire transverse section of the turn and which passes through the helical channel or conduit from the input coupling 12 as far as the output coupling 13, this portion of liquid receives by heat exchange partial quantities of heat according to the point on the rotary machine with which it is momentary in contact and according to its momentary heat reception capacity. Consequently, when a helical channel or conduit comprises several successive turns, the portion of cooling liquid heats up from turn to turn and, also from turn to turn, becomes less and less capable of taking heat from the machine. The result is good cooling by the input coupling 12 and less good, if not poor, cooling by the output coupling 13.

If on the other hand the helical channel or conduit comprises only one turn or several adjacent single turns, the portion of cooling liquid in question runs, comparatively speaking, in the one turn or, in each of the adjacent single turns, only through the “first” turn and immediately leaves the helical channel or conduit. The result is good cooling over the entire width of the channel or conduit 11.

By virtue of the substantially tangential arrival and departure of the cooling liquid, there is no detrimental turbulence that, previously, had the effect of constituting a significant flow resistance, detrimental both to the speed of the cooling fluid and to the heat transfer capacity from the rotary machine to the cooling fluid.

FIG. 3 depicts in a perspective view a cooling fluid envelope constituting the external wall which forms, together with the external surface of the stator 14 as the internal wall, the helical channel or conduit 11 according to the invention. This view shows more particularly the circumferential extent of the input zone of the input coupling 12 and of the output zone of the output coupling 13. The location of the references Z1 and Z2 in this figure corresponds essentially to the tangential inlet of the inlet coupling 12 and the tangential departure of the output couplet 13.

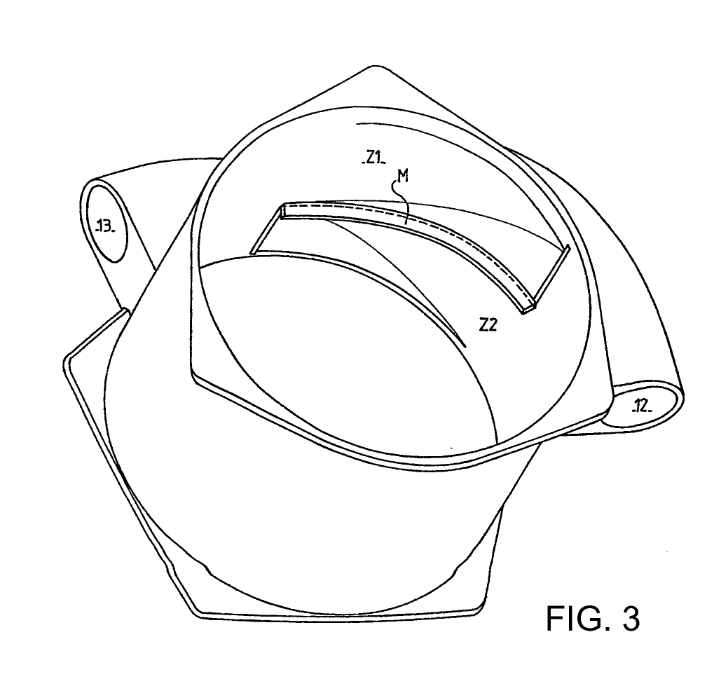

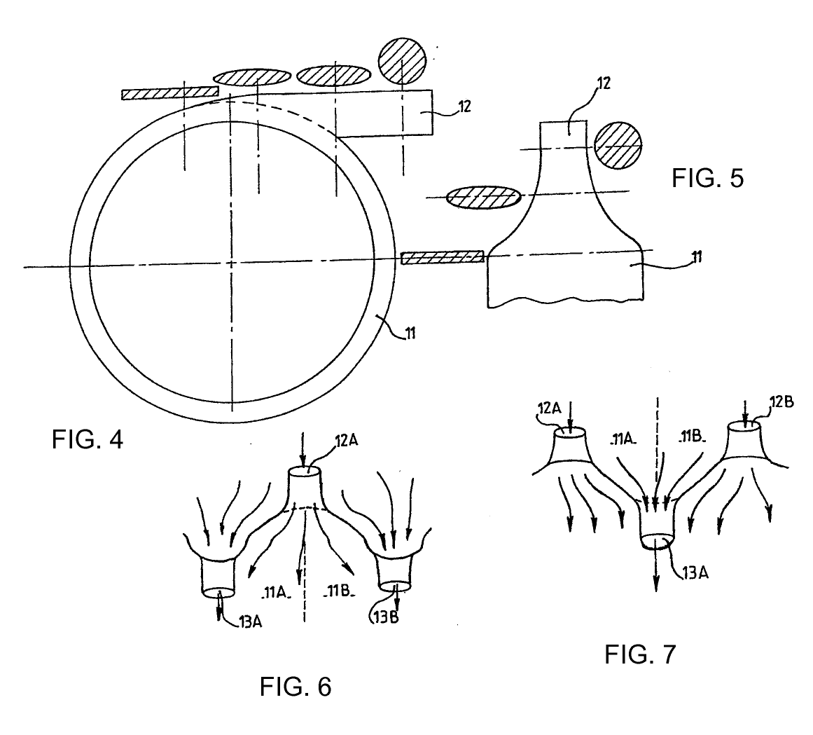

In addition, according to one characteristic of the invention, in order to ensure a constant flow through the single turn constituted by the cooling channel or conduit length according to the invention, whilst taking account of the design particularities according to which use is in general made of a channel or conduit with a circular cross section for the feed and output channels or conduits of a cooling circuit whilst the transverse section of the length surrounding the rotor machine to be cooled has a generally rectangular cross section, the input and output couplings 12, 13 are conformed so as to have, all along their longitudinal extent, a constant area of their cross section of flow, as is shown schematically in FIGS. 4 and 5.

FIG. 3 also shows that the inlet zone of the input coupling 12 and the outlet zone where the output coupling 13 commences, are separated from each other by a changing low wall M conformed so as to grant a favored flow direction to the cooling fluid.

This is because the cooling fluid arrives in the zone Z1 at a fairly high speed and pressure and encounters a fluid with a lower pressure leaving through the zone Z2. So that the exchange surface between the incoming flow and the outgoing flow is relatively small and therefore does not promote any appreciable interaction between the two flows, it could nevertheless happen that the encounter between the two flows creates a turbulence zone that greatly impairs the effective flow of the cooling fluid. Some of the flow of the fluid could then pass directly from the arrival zone to the outlet zone and in some way “short-circuit” the turn, that is to say leave immediately, without making a complete turn of the cooling chamber. In order to prevent this, the changing low wall M separates the arrival zone Z1 from the output zone Z2, the height of the low wall M corresponding to the height of the helical channel or conduit 11.

FIG. 4 shows the channel or conduit 11 according to the invention with an input coupling 12. The cross section of flow of the input coupling 12 is shown above the latter at four different points in order thus to demonstrate the change in shape of the cross section of flow whilst keeping the area of flow constant.

FIG. 5 shows, schematically in a side view, the coupling 12 and the start of the length 11. The cross section of flow of the input coupling 12 is shown alongside the latter at three different points in order thus to demonstrate the change in shape of the cross section of flow whilst keeping the area of flow constant.

The cooling channel length according to the invention can also consist of two or more adjacent single turns, as is shown in FIGS. 6 and 7. This is because, instead of having a single turn 11 whose width corresponds approximately to half the axial extent available for cooling the rotary machine, this axial extent of the machine is divided into two or more equal parts and mounts the same number of single turns one alongside the other. FIGS. 6 and 7 show a length having two adjacent turns 11A and 11B. The width of each of these turns is then only the corresponding part of the axial extent available for cooling the machine to be cooled. At the same time, these single turns are disposed and formed so that each input coupling 12A, 12B or each output coupling 13A, 13B is in common with two adjacent turns 11A/11B.

The result is the combination of turns, chosen purely for indication and in no way limitingly, shown in FIGS. 6 and 7:

FIG. 6: two turns with a common central input 12A and two outputs 13A, 13B on the peripheries on each side of the input 12A;

FIG. 7: two turns with a two inputs 12A, 12B and one common central output 13A between the inputs 12A, 12B.

The same principles of dimensions apply to all these provisions as for the embodiment according to FIGS. 4 and 5, that is to say the constant area of the cross section of flow must be provided over the entire extent of the input couplings and output couplings.

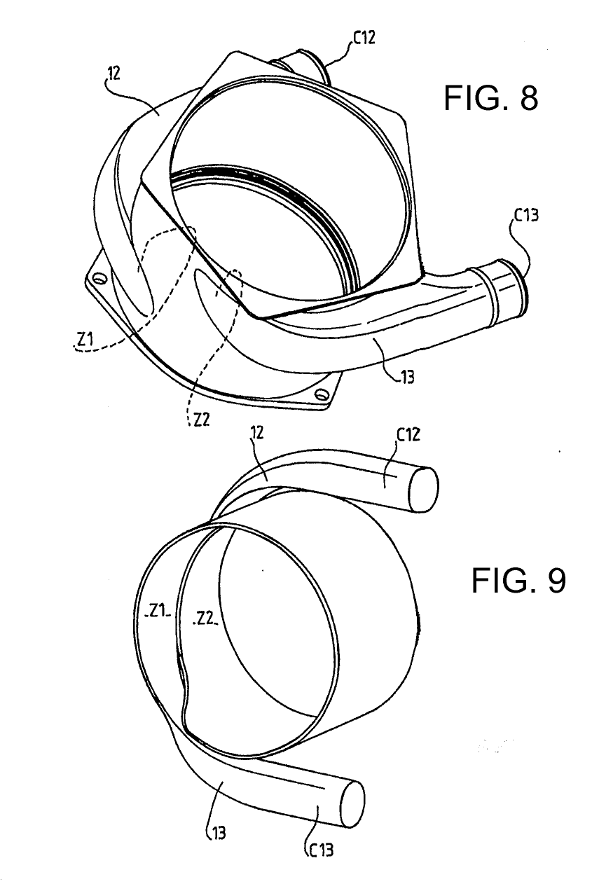

FIG. 8 shows a variant embodiment of the cooling fluid envelope in FIG. 3 which consists essentially of two channels or conduits respectively extending the input coupling 12 and the output coupling 13 so as to obtain a feed channel or conduit C12 oriented parallel to a discharge channel or conduit C13. The change in shapes of the cross sections of the rectangular couplings 12 and 13 into round channel or conduits C12 and C13 will be noted in particular, in the areas where the cross sections of flow remain constant, in accordance with the invention.

It will be noted that the internal wall of the envelope constitutes here the external wall of the stator of the electrical machine, as in FIG. 2 of the document EP-A-0 331 559.

In FIG. 8 the flange for fixing to a framework of the vehicle can be seen partially.

FIG. 9 shows the volume of fluid when it passes through the cooling fluid envelope depicted in FIG. 8. To simplify the marking of the various parts of the flow length, these bear the same reference numbers as the corresponding parts of the cooling fluid envelope in FIG. 8.

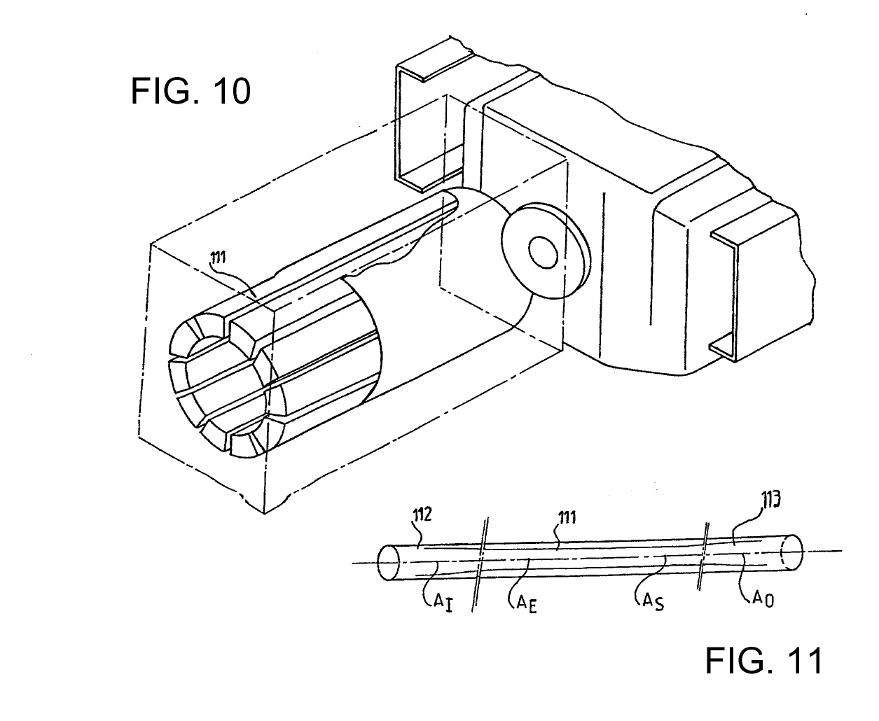

FIGS. 10 and 11 show another embodiment of the length according to the invention. This length is formed by channels or conduits parallel to each other and disposed in parallel around the longitudinal axis of the machine to be cooled. The input 112 and output 113 couplings, which advantageously have a round transverse section, are disposed coaxially with respect to each channel or conduit 111 to which they are allocated. In order to form a closed cooling fluid envelope, that is to say entirely surrounding the body of the machine to be cooled, the channels or conduits 111 have a transverse section of an annular sector.

Naturally the invention is not limited to the example embodiments described above. Thus the presence of the speed multiplier is not obligatory, the shaft of the rotor being able to be connected to the output shaft of the gearbox as described in the document EP-A-0 331 559, or in a variant to the input shaft of the rear axle.

The rotary electrical machine is in a variant an alternator with a liquid cooling circuit as described for example in the document FR-A-2 780 571.

This alternator can be reversible in order in particular to constitute an electric motor so as to start the thermal engine of the motor vehicle. Such an alternator is called an alternator/starter.

While the form of apparatus and methods herein described constitute preferred embodiments of this invention, it is to be understood that the invention is not limited to this precise method and form of apparatus, and that changes may be made therein without departing from the scope of the invention, which is defined in the appended claims.

What is claimed is:

1. A cooling channel or conduit length for a rotary electrical machine, the channel or conduit length comprising at least one channel or conduit placed along at least part of the machine to be cooled and having an input axis and an output axis, as well as at least one input coupling and at least one output coupling for a cooling fluid and between which said at least one channel or conduit extends, characterized in that said at least one input coupling or couplings and said at least one output coupling or couplings are each oriented at least approximately along the orientation of the corresponding input axis or output axis, respectively, of the channel or conduit and have, all along their longitudinal extents, a generally constant area of their cross section of flow.

2. The cooling channel or conduit length according to claim 1, characterized in that the channel or conduit is a helical channel or conduit having at least one turn intended to surround at least part of the machine to be cooled and having respectively an input axis and an output axis oriented along a tangential axis or plane passing through an input and output circumferential zone of the length, respectively, and said at least one input coupling and said at least one output coupling.

3. The cooling channel or conduit length according to claim 2, characterized in that said input coupling and said at least one output coupling are disposed, in an axial view of the length, with a small angular difference between the two couplings.

4. The cooling channel or conduit length according to claim 2, characterized in that said helical channel or conduit is formed by two complementary walls, an internal wall and said external wall, the external wall being formed by a cooling fluid envelope conformed so as to grant to the cooling fluid a helical path with a single turn.

5. The cooling channel or conduit length according to claim 4, characterized in that it comprises a single part joining said at least one input coupling and said at least one output coupling, these two couplings being separated from each other by a changing low wall conformed so as to give a favored flow direction to the cooling fluid.

6. The cooling channel or conduit length according to claim 1, characterized in that said cooling channel or conduit length comprises two adjacent turns with an input coupling in common and an individual output coupling for each turn.

7. The cooling channel or conduit length according to claim 1, characterized in that said cooling channel or conduit length comprises two adjacent turns with an individual input coupling each turn and a common output coupling,

8. The cooling channel or conduit length according to claim 1, characterized in that said cooling channel or conduit length comprises conduits parallel to each other and disposed in parallel around the longitudinal axis of the machine to be cooled, said at least one input coupling and said at least one output coupling being disposed coaxially with respect to the channel or conduit to which they are allocated.

9. A rotary electrical machine, characterized in that it comprises a cooling length according to claim 1.

10. The cooling channel or conduit length as recited in claim 3, wherein said small angle difference is between 20 and 30 percent.

11. A cooling channel or conduit for cooling a rotary electrical machine, the cooling channel or conduit comprising at least one channel or conduit placed along at least part of the machine to be cooled and having at least one input coupling and at least one output coupling for a cooling fluid and between which said at least one channel or conduit extends, characterized in that said at least one input coupling or couplings and said at least one output coupling or couplings are each oriented such that a fluid enters through said at least one input at a first flow rate, into said at least one channel or conduit, and exits said at least one output at substantially a second flow rate, said first and second flow rates being generally the same.

12. The cooling channel or conduit as recited in claim 11, wherein said at least one channel or conduit comprises an input axis and an output axis, said at least one input causing fluid to enter said at least one channel or conduit along said input axis and said at least one output causing fluid to exit said at least one channel or conduit along said output axis; said input and output axes being oriented at least approximately along a tangent to a point determined by a radial line extending to a circumference of said at least one cooling channel or conduit.

13. The cooling channel or conduit as recited in claim 11, characterized in that the cooling channel or conduit is a helical channel or conduit having at least one turn intended to surround at least part of the machine to be cooled and having respectively an input axis and an output axis oriented along a tangential axis or plane passing through a input and output circumferential zone of the length, respectively, and at least one input coupling and at least one out coupling.

14. The cooling channel or conduit according to claim 13, characterized in that said input coupling and said at least one output coupling are disposed, in an axial view of the length, with a small angular difference between the two couplings.

15. The cooling channel or conduit according to claim 13, characterized in that said helical channel or conduit is formed by two complementary walls, an internal wall and said external wall, the external wall being formed by a cooling fluid envelope conformed so as to grant to the cooling fluid a helical path with a single turn.

16. The cooling channel or conduit according to claim 15, characterized in that it comprises a single part joining said at least one input coupling and said at least one output coupling, these two couplings being separated from each other by a changing low wall conformed so as to give a favored flow direction to the cooling fluid.

17. The cooling channel or conduit according to claim 11, characterized in that said cooling channel or conduit length comprises two adjacent turns with an input coupling in common and an individual output coupling for each turn.

18. The cooling channel or conduit according to claim 11, characterized in that said cooling channel or conduit length comprises two adjacent turns with an individual input coupling each turn and a common output coupling,

19. The cooling channel or conduit according to claim 11, characterized in that said cooling channel or conduit length comprises channels or conduits parallel to each other and disposed in parallel around the longitudinal axis of the machine to be cooled, said at least one input coupling and said at least one output coupling being disposed coaxially with respect to the channel or conduit to which they are allocated.

20. A rotary electrical machine, characterized in that it comprises a cooling length according to claim 11.
